(19) United States
(12) Patent Application Publication
(10) Pub. No.: US 2026/0169186 A1
(43) Pub. Date: Jun. 18, 2026

(54) AUTO-FORMATION TOPS PREDICTION USING CNN

(71) Applicant: Schlumberger Technology Corporation, Sugar Land, TX (US)

(72) Inventors: Shady Attia, Dhahran (SA); Abdullah Yaseen Albuali, Dhahran (SA)

(21) Appl. No.: 18/981,190

(22) Filed: Dec. 13, 2024

(51) Int. Cl. G01V 20/00; E21B 44/00

(52) U.S. Cl. CPC G01V 20/00; E21B 44/00; E21B 2200/22

(57) ABSTRACT

A method for automatically predicting subsurface formation tops based upon well log data using a convolutional neural network (CNN) includes receiving first well log data corresponding to a plurality of first wells. The first well log data includes first marker tops in the first wells. Labels on the first sequences indicate a presence or absence of first formation tops within first sequences in the first well log data. The method also includes training a convolutional neural network (CNN) using the cleansed well log data. The method also includes receiving second well log data corresponding to a plurality of second wells. The method also includes identifying second formation tops in the second well log data using the trained CNN. Identifying the second formation tops includes predicting a probability that one or more second marker tops is in each of a plurality of second sequences in the second well log data.

### BACKGROUND

Formation tops are the depths in a well (measured in feet below a reference elevation) at which formations are found in the subsurface. Conventional formation top-picking relies on expert interpretation of well logs, which involves extensive geoscientific knowledge and a large amount of time per well. More particularly, manually identifying formation tops (e.g., geological boundaries) within well logs is a process that is time-consuming, labor-intensive, and subject to human error. Therefore, what is needed is an improved system and method for identifying or predicting formation tops.

### SUMMARY

A method for automatically predicting subsurface formation tops based upon well log data using a convolutional neural network (CNN) is disclosed. The method includes receiving first well log data corresponding to a plurality of first wells formed in a subsurface. The first well log data includes first marker tops in the first wells. The method also includes cleansing the first well log data to produce cleansed well log data. The cleansed well log data includes a plurality of first sequences. Each of the first sequences represents a slice of the first well log data. Labels on the first sequences indicate a presence or absence of first formation tops within the first sequences. The method also includes training a convolutional neural network (CNN) using the cleansed well log data to produce a trained CNN. The method also includes receiving second well log data corresponding to a plurality of second wells formed in the subsurface. The second well log data includes a plurality of second sequences. The method also includes identifying second formation tops in the second well log data using the trained CNN. Identifying the second formation tops includes predicting a probability that one or more second marker tops is in each of the second sequences in the second well log data.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an overview of an automated well tops picking workflow, according to an embodiment.

FIG. 3 illustrates a flowchart of a method for automatically predicting subsurface formation tops based upon well log data using a convolutional neural network (CNN), according to an embodiment.

FIG. 4A illustrates first well log data (e.g., a gamma ray log), and FIG. 4B illustrates the 1D gamma ray log converted into a 2D image to be compatible with the CNN, according to an embodiment.

FIG. 5A illustrates another example of first well log data, and FIG. 5B illustrates first formation tops identified in the first well log data, according to an embodiment.

FIG. 6A illustrates second well log data, and FIG. 6B illustrates second formation tops identified in the second well log data, according to an embodiment.

FIG. 7 illustrates a schematic view of the CNN predicting second marker tops (e.g., depths) based upon the second well log data, according to an embodiment.

FIG. 8 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

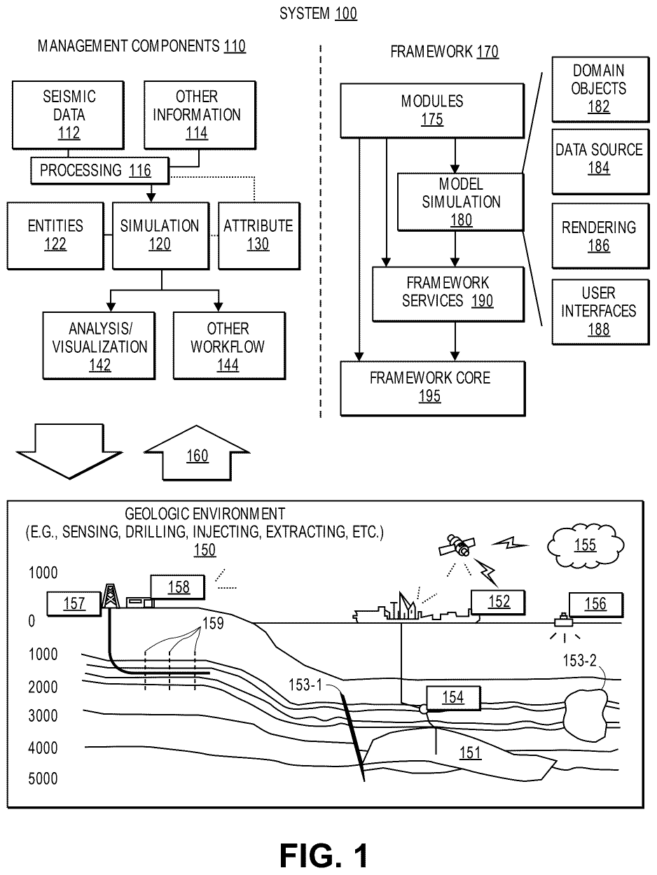

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (SLB, Houston Texas), the INTERSECT™ reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (SLB, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (SLB, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more predefined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

### Auto-Formation Tops Prediction Using CNN

The present disclosure solves the problem of manually identifying formation tops (e.g., geological boundaries) within well logs, a process that is time-consuming, labor-intensive, and subject to human error. The method described herein uses a convolutional neural network (CNN) model to automate the detection of formation tops, making the process faster, more consistent, and scalable across multiple wells. This allows geologists to allocate their time to more complex interpretations, ultimately improving the accuracy and efficiency of subsurface mapping, reservoir characterization, and field development planning.

More particularly, the method solves the problem by using a custom-designed CNN model that accurately predicts formation tops in well log data. By analyzing depth-specific patterns in a windowed format, it identifies formation changes with high precision. This approach is both scalable and resource-efficient, making it ideal for real-time applications in oil and gas exploration.

The method may use a customized CNN architecture. More particularly, the model may be built to handle well log data uniquely, capturing subtle indicators of formation tops without needing extensive labeled data. In addition, the method may use a depth-sensitive analysis. More particularly, it uses a windowed approach to maintain depth sensitivity, unlike many conventional models that struggle across varying depths. The CNN architecture may provide scalability and efficiency. The model can handle large datasets across multiple wells, making it highly scalable, while also optimized for minimal computational resources, ideal for field applications.

As mentioned above, the deep learning model uses convolutional neural networks (CNNs) to predict formation tops in well log data. The model analyzes depth-related features and identifies geological formations accurately, making it highly efficient and practical for real-time use in subsurface exploration. This approach enhances precision in formation analysis. The method enhances data processing capabilities by reducing the time and effort for formation top picking, thereby increasing operational efficiency. It ensures higher accuracy and consistency in geological interpretations.

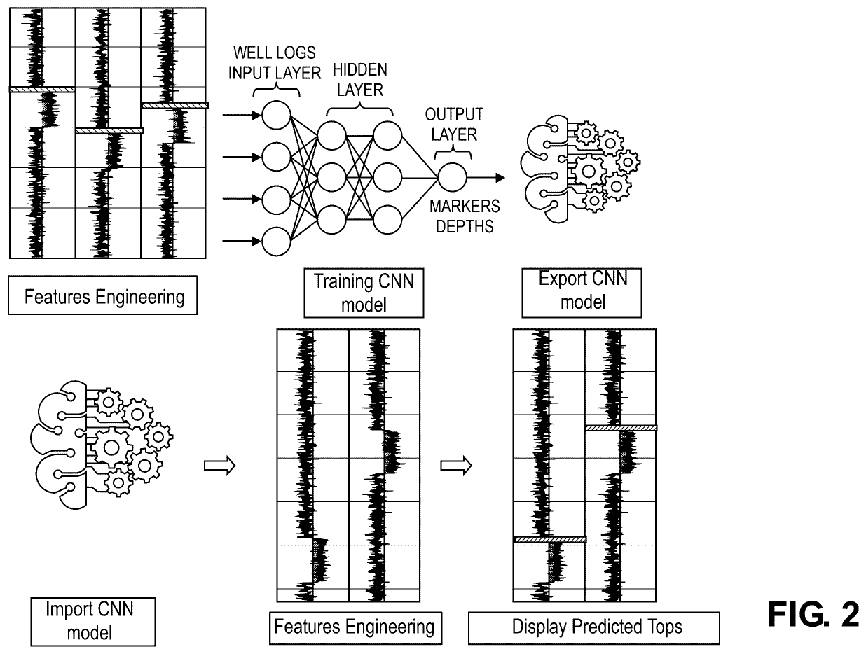

FIG. 2 illustrates an overview of an automated well tops picking workflow, according to an embodiment. The workflow involves the following technical steps, leveraging a combination of data preparation, supervised machine learning, and deep learning model training.

### Data Preparation

Well logs may be collected and received for a range of wells. The data in the well logs may include gamma ray, density, and/or neutron logs. The well log data may serve as the primary input features for the model. Additional metadata, such as well names, depths, and marker tops (e.g., Top01, Top02), may also be aggregated. The data preparation may also include marker depth annotation. More particularly, depth dictionaries may be used to store and locate the known depths of specific formation tops within each well, enabling the model to learn from expert-picked markers.

### Data Cleansing

Negative and extreme outlier values in the log data (e.g., −9999) may be replaced with null values (e.g., NaN) and subsequently dropped or interpolated as part of data preprocessing. This ensures data quality and reduces noise that may affect model accuracy.

The data cleansing may also include data transformation and normalization. More particularly, the well log data may be scaled to a normalized range using a minmaxscaler. This scaling allows for uniformity across different log measurements, which helps in model convergence and improves the reliability of predictions.

The data cleansing may also include sequence generation. More particularly, the data may be split into sequences based on defined window sizes (e.g., sequence_length of 10 for Top 01 and 20 for Top02). Each sequence represents a slice of continuous log data and serves as the input for the CNN, while labels indicate the presence or absence of a formation top within the sequence.

### Model Architecture and Training

The method uses a sequential CNN model architecture that includes convolutional one-dimensional (Conv1D) layers that apply filters across the sequences to detect spatial patterns within the logs. The model also uses maxpooling1D layers to reduce the dimensionality of data and retain selected features, enhancing model efficiency and robustness. The model also uses dense and dropout layers to fully connect and regularize the model, optimizing generalization and preventing overfitting. The model also uses a flatten layer to convert the multidimensional output into a one-dimensional vector, followed by a final dense layer with sigmoid activation to produce binary classification predictions for top detection.

The model may be trained with a binary cross-entropy loss function, designed to distinguish sequences containing marker tops from those without. Batch processing and validation datasets allow for iterative optimization, with performance metrics monitored for model accuracy.

### Prediction and Validation

The prediction and validation may include marker top identification. More particularly, after training, the model identifies formation tops within the logs by predicting the probability of a marker top in each sequence. High-probability sequences may be flagged as containing potential tops, and this preliminary output is provided to geologists for verification and fine-tuning.

The prediction and validation may also include range filtering. More particularly, to limit the model to relevant geological formations, filtering thresholds based on the observed minimum and maximum surface depths may be applied. This filtering narrows predictions to geologically plausible ranges, enhancing prediction specificity and alignment with known stratigraphic markers.

### Final Workflow Automation

The automation may include batch processing. More particularly, the entire prediction workflow may be configured for batch processing, facilitating high-throughput, large-scale predictions across multiple wells in parallel. This automation reduces the time to process extensive well logs from months to hours, thereby improving the efficiency of subsurface modeling. The final predictions, though automated, are designed to be reviewed by domain experts. This review process ensures that automated picks meet accuracy standards, with provisions for adjustments based on domain knowledge, thereby providing flexibility and quality assurance.

### Differentiation from Existing Solutions

This method uniquely combines CNN-based deep learning with preprocessing tailored to geological data requirements, such as specific well log handling, data normalization, and specialized range filtering. Unlike conventional methods that involve extensive manual intervention, this method achieves full automation while remaining transparent and adaptable to expert validation. It also incorporates a scalable batch processing capability, making it suitable for large datasets—an advantage over conventional methodologies.

### Summary and Value Addition

In summary, the method is a robust, CNN-driven formation top predictor designed to process high-dimensional well log data with unprecedented speed and accuracy. It allows geologists and engineers to automate routine top-picking tasks while retaining the ability to adjust predictions based on expert knowledge. The method provides valuable time and cost savings by reducing manual data processing, ensuring consistency across wells, and enhancing the predictive accuracy of formation tops. Its scalability and adaptability make it a valuable tool in the energy industry, adding efficiency and reliability to well log analysis and reservoir characterization workflows.

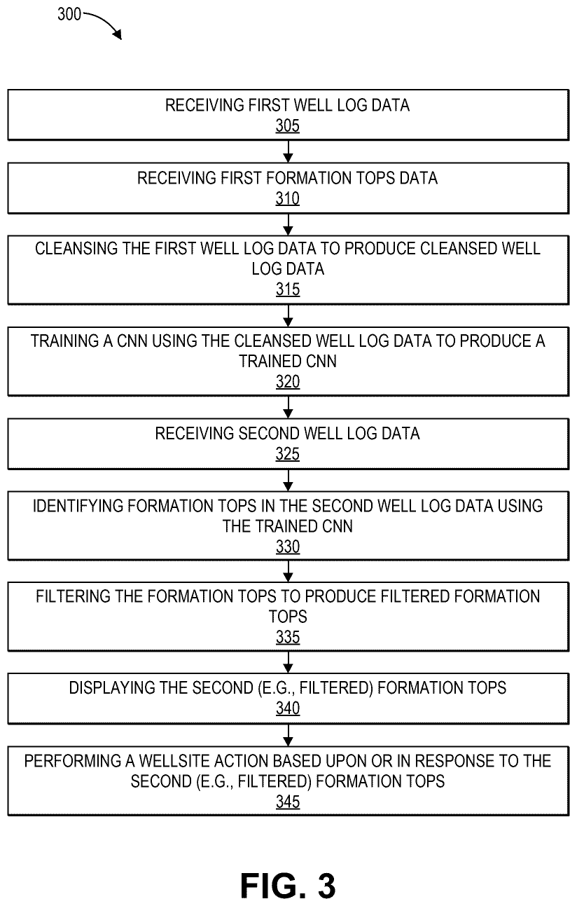

FIG. 3 illustrates a flowchart of a method 300 for automatically predicting subsurface formation tops based upon well log data using a convolutional neural network (CNN), according to an embodiment. An illustrative order of the method 300 is provided below; however, one or more portions of the method 300 may be performed in a different order, simultaneously, repeated, or omitted. At least a portion of the method 300 may be performed with a computing system (described below).

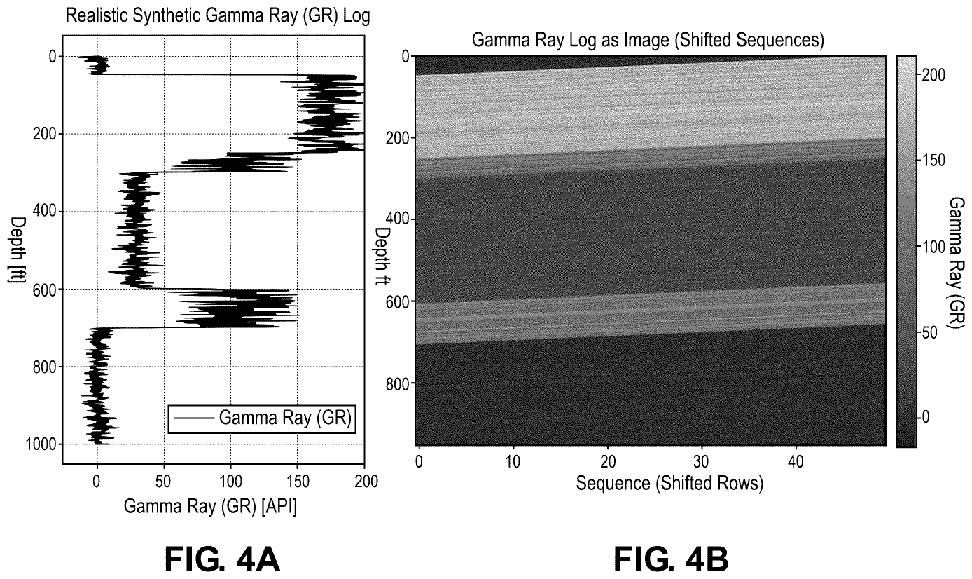

The method 300 may include receiving first well log data, as at 305. The first well log data may correspond to a plurality of first wells formed in a subsurface. The first well log data may include gamma ray logs, density logs, neutron logs, or a combination thereof. The first well log data may also include names of the first wells, depths of the first wells, first marker tops in the first wells, or a combination thereof. FIG. 4A illustrates first well log data (e.g., a gamma ray log), and FIG. 4B illustrates the 1D gamma ray log converted into a 2D image to be compatible with a convolutional neural network (CNN), according to an embodiment.

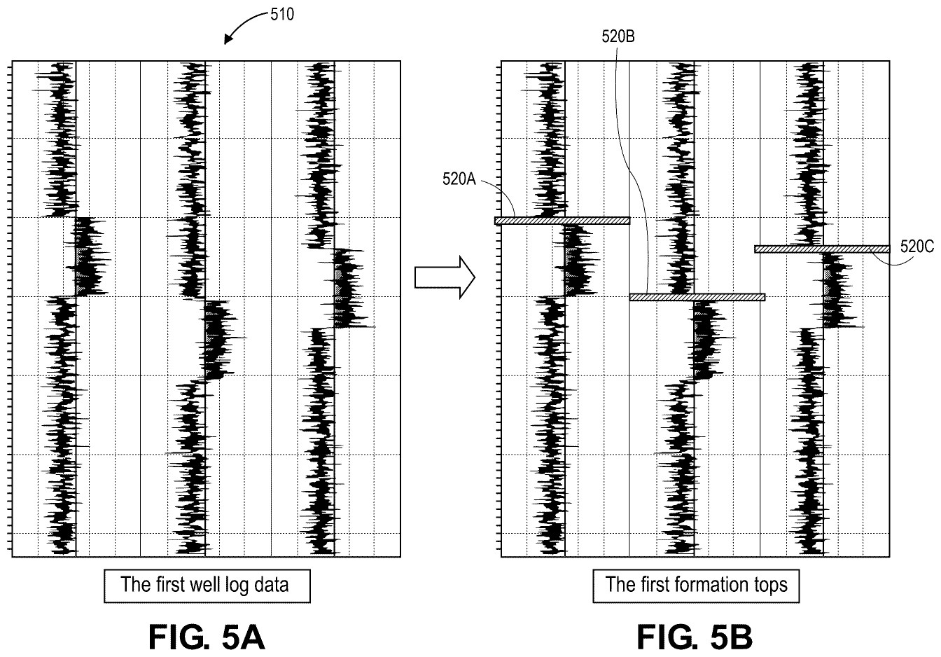

The method 300 may also include receiving first formation tops data, as at 310. The first formation tops data may correspond to first formation tops in the first wells. Depth dictionaries may be used to identify known depths of the first formation tops within each of the first wells. FIG. 5A illustrates another example of first well log data 510, and FIG. 5B illustrates the first formation tops 520A-520C identified in the first well log data 510, according to an embodiment.

The method 300 may also include cleansing the first well log data to produce cleansed well log data, as at 315. Cleansing the well log data may include scaling the first well log data to produce scaled well log data. The first well log data may be scaled to a normalized range to provide uniformity across different measurements in the first well log data. The first well log data may be scaled using a minmaxscaler.

Cleansing the well log data may also include splitting the scaled well log data into a plurality of first sequences to produce the cleansed well log data. The scaled well log data may be split based upon one or more defined window sizes. The cleansed well log data may be in a 2D array. Each of the first sequences represents a slice of the first well log data. Labels on the first sequences may indicate a presence or absence of the first formation tops within the first sequences.

The method 300 may also include training the CNN using the cleansed well log data to produce a trained CNN, as at 320. Training the CNN may include applying filters to the cleansed well log data to produce filtered well log data. Applying the filters detects spatial patterns within the first sequences. Applying the filters comprises may include the first sequences through one or more convolutional one-dimensional layers of the CNN.

Training the CNN may also include reducing a dimensionality of the filtered well log data to produce reduced well log data. Reducing the dimensionality may include passing the filtered well log data through one or more maxpooling one-dimensional layers of the CNN.

Training the CNN may also include connecting and regularizing the reduced well log data to produce connected and regularized well log data. Connecting and regularizing the reduced well log data generalizes the reduced well log data and/or prevents overfitting within the reduced well log data. Connecting and regularizing the reduced well log data may include passing the reduced well log data through one or more dense and dropout layers of the CNN.

Training the CNN may also include converting the connected and regularized well log data from a multi-dimensional output into a one-dimensional vector using a flatten layer of the CNN.

Training the CNN may also include predicting a binary classification for the first formation tops based upon the one-dimensional vector. The binary classification may be predicted using a dense layer of the CNN. The dense layer may use or include sigmoid activation.

Training the CNN may also include training the CNN with a binary cross-entropy loss function that is configured to distinguish the first sequences containing the first marker tops from those without the first marker tops. The binary cross-entropy loss function may be determined or based upon the binary classification.

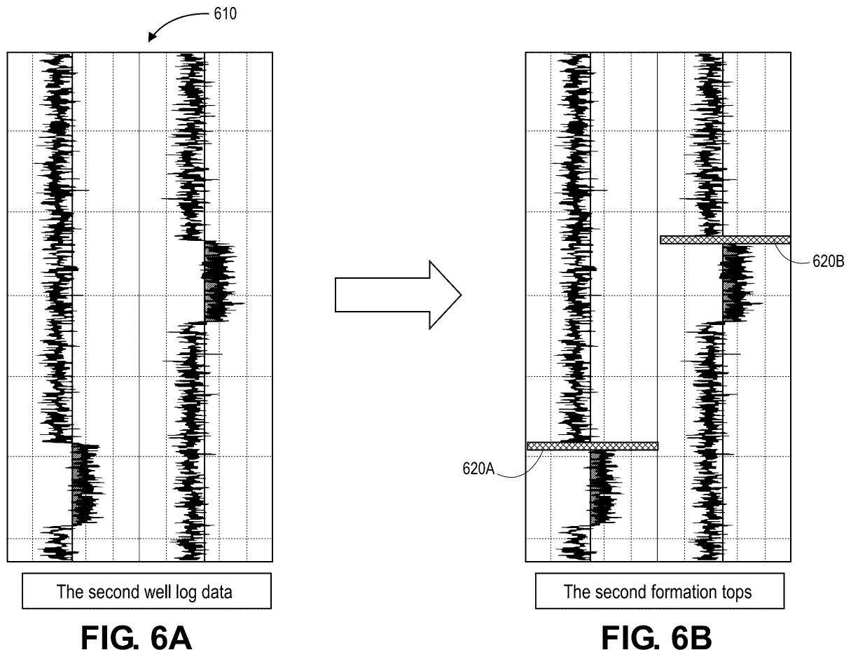

The method 300 may also include receiving second well log data, as at 325. FIG. 6A illustrates second well log data 610, according to an embodiment. The second well log data may correspond to a plurality of second wells formed in the subsurface. The second well log data may include the gamma ray logs, the density logs, the neutron logs, or a combination thereof. The second well log data may also include the names of the second wells and the depths of the second wells. The second well log data may include a plurality of second sequences. The second well log data may not include second formation tops data.

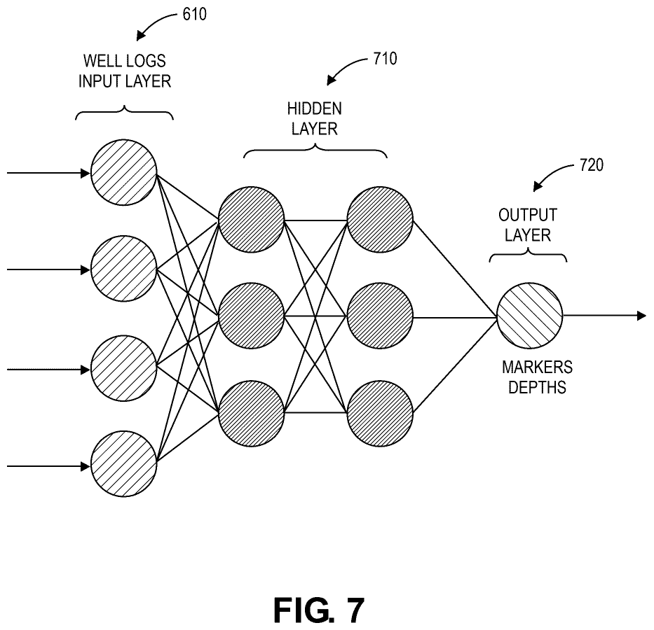

The method 300 may also include identifying second formation tops in the second well log data using the trained CNN, as at 330. FIG. 6B illustrates the second formation tops 620A-620C identified in the second well log data 610, according to an embodiment. Identifying the second formation tops may include predicting a probability that one or more of the second marker tops is in each of the second sequences in the second well log data. FIG. 7 illustrates a schematic view of the CNN 710 predicting the second marker tops (e.g., depths) 720 based upon the second well log data 610, according to an embodiment. Predicting the probability may include determining an area of a deviation of the second sequences from a predicted probability log. As the area increases, the probability increases.

The method 300 may also include filtering the second formation tops to produce filtered formation tops, as at 335. The second formation tops may be filtered to those within a portion of the area where the probability is highest (e.g., spiking). These areas may be converted to depths.

The method 300 may also include displaying the second formation tops, as at 340. For example, this may include displaying the filtered formation tops.

The method 300 may also include performing a wellsite action based upon or in response to the second formation tops (e.g., the filtered formation tops), as at 345. The wellsite action may be or include generating and/or transmitting a signal (e.g., using a computing system) that instructs or causes a physical action to occur at a wellsite. The wellsite action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like.

### Exemplary Computing System

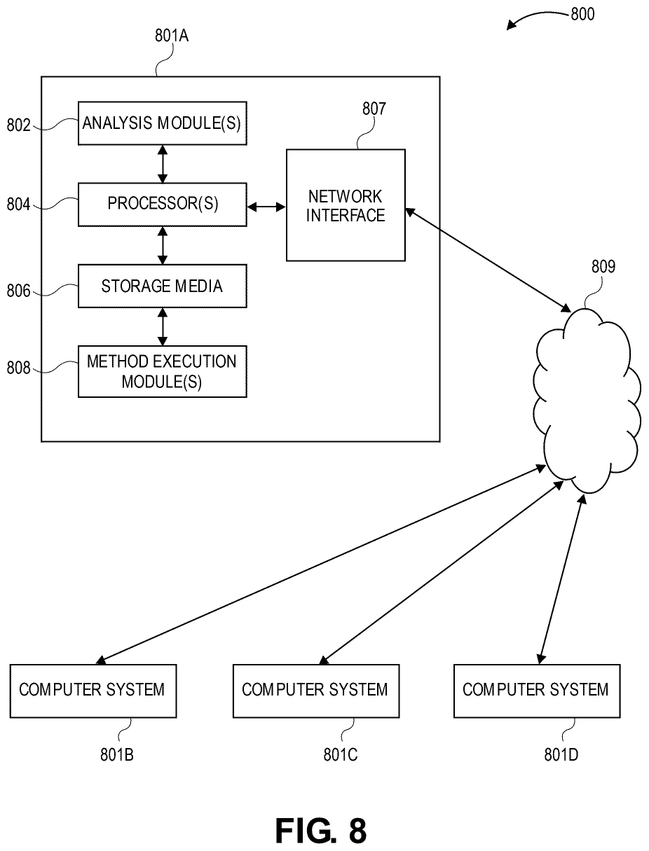

In some embodiments, the methods of the present disclosure may be executed by a computing system. FIG. 8 illustrates an example of such a computing system 800, in accordance with some embodiments. The computing system 800 may include a computer or computer system 801A, which may be an individual computer system 801A or an arrangement of distributed computer systems. The computer system 801A includes one or more analysis modules 802 that are configured to perform various tasks according to some embodiments, such as one or more methods disclosed herein. To perform these various tasks, the analysis module 802 executes independently, or in coordination with, one or more processors 804, which is (or are) connected to one or more storage media 806. The processor(s) 804 is (or are) also connected to a network interface 807 to allow the computer system 801A to communicate over a data network 809 with one or more additional computer systems and/or computing systems, such as 801B, 801C, and/or 801D (note that computer systems 801B, 801C and/or 801D may or may not share the same architecture as computer system 801A, and may be located in different physical locations, e.g., computer systems 801A and 801B may be located in a processing facility, while in communication with one or more computer systems such as 801C and/or 801D that are located in one or more data centers, and/or located in varying countries on different continents).

A processor may include a microprocessor, microcontroller, processor module or subsystem, programmable integrated circuit, programmable gate array, or another control or computing device.

The storage media 806 may be implemented as one or more computer-readable or machine-readable storage media. Note that while in the example embodiment of FIG. 8 storage media 806 is depicted as within computer system 801A, in some embodiments, storage media 806 may be distributed within and/or across multiple internal and/or external enclosures of computing system 801A and/or additional computing systems. Storage media 806 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 800 contains one or more method execution module(s) 808. In the example of computing system 800, computer system 801A includes the method execution module 808. In some embodiments, a single method execution module may be used to perform some aspects of one or more embodiments of the methods disclosed herein. In other embodiments, a plurality of method execution modules may be used to perform some aspects of methods herein.

It should be appreciated that computing system 800 is merely one example of a computing system, and that computing system 800 may have more or fewer components than shown, may combine additional components not depicted in the example embodiment of FIG. 8, and/or computing system 800 may have a different configuration or arrangement of the components depicted in FIG. 8. The various components shown in FIG. 8 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 800, FIG. 8), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for automatically predicting subsurface formation tops based upon well log data using a convolutional neural network (CNN), the method comprising:
receiving first well log data corresponding to a plurality of first wells formed in a subsurface, wherein the first well log data comprises first marker tops in the first wells;
cleansing the first well log data to produce cleansed well log data, wherein the cleansed well log data comprises a plurality of first sequences, and wherein labels on the first sequences indicate a presence or absence of first formation tops within the first sequences;
training a convolutional neural network (CNN) using the cleansed well log data to produce a trained CNN;
receiving second well log data corresponding to a plurality of second wells formed in the subsurface; and
identifying second formation tops in the second well log data using the trained CNN, wherein identifying the second formation tops comprises predicting a probability that one or more second marker tops is in each of a plurality of second sequences in the second well log data.

2. The method of claim 1, wherein cleansing the first well log data comprises scaling the first well log data, wherein the first well log data is scaled to a normalized range to provide uniformity across different measurements in the first well log data, and wherein the first well log data is scaled using a minmaxscaler.

3. The method of claim 2, wherein cleansing the first well log data further comprises splitting the first well log data into the first sequences, wherein the first well log data is split based upon one or more defined window sizes, and wherein the cleansed well log data is in a 2D array.

4. The method of claim 1, wherein training the CNN comprises applying filters to the cleansed well log data, wherein the filters detect spatial patterns within the first sequences, and wherein the applying the filters comprises passing the first sequences through one or more convolutional one-dimensional layers of the CNN.

5. The method of claim 1, wherein training the CNN comprises reducing a dimensionality of the cleansed well log data, wherein reducing the dimensionality comprises passing the cleansed well log data through one or more maxpooling one-dimensional layers of the CNN.

6. The method of claim 1, wherein training the CNN comprises connecting and regularizing the cleansed well log data, wherein connecting and regularizing the cleansed well log data generalizes the cleansed well log data and prevents overfitting within the cleansed well log data, and wherein connecting and regularizing the cleansed well log data comprises passing the cleansed well log data through one or more dense and dropout layers of the CNN.

7. The method of claim 1, wherein training the CNN comprises converting the cleansed well log data from a multi-dimensional output into a one-dimensional vector using a flatten layer of the CNN.

8. The method of claim 7, wherein training the CNN comprises predicting a binary classification for the first formation tops in the first wells based upon the one-dimensional vector, wherein the binary classification is predicted using a dense layer of the CNN, and wherein the dense layer comprises sigmoid activation.

9. The method of claim 1, wherein training the CNN comprises training the CNN with a binary cross-entropy loss function that is configured to distinguish the first sequences containing the first marker tops from those without the first marker tops.

10. The method of claim 1, further comprising performing a wellsite action based upon or in response to the second formation tops, wherein the wellsite action comprises generating and/or transmitting a signal that instructs or causes a physical action to occur at a wellsite, and wherein the physical action comprises selecting where to drill a wellbore, drilling the wellbore, varying a weight and/or torque on a drill bit that is drilling the wellbore, varying a drilling trajectory of the wellbore, or varying a concentration and/or flow rate of a fluid pumped into the wellbore.

11. A computing system, comprising:
one or more processors; and
a memory system comprising one or more non-transitory computer-readable media storing instructions that, when executed by at least one of the one or more processors, cause the computing system to perform operations, the operations comprising:
receiving first well log data corresponding to a plurality of first wells formed in a subsurface, wherein the first well log data comprises first marker tops in the first wells;
cleansing the first well log data to produce cleansed well log data, wherein the cleansed well log data comprises a plurality of first sequences, wherein each of the first sequences represents a slice of the first well log data, and wherein labels on the first sequences indicate a presence or absence of first formation tops within the first sequences;
training a convolutional neural network (CNN) using the cleansed well log data to produce a trained CNN;
receiving second well log data corresponding to a plurality of second wells formed in the subsurface, wherein the second well log data comprises a plurality of second sequences; and
identifying second formation tops in the second well log data using the trained CNN, wherein identifying the second formation tops comprises predicting a probability that one or more second marker tops is in each of the second sequences in the second well log data.

12. The computing system of claim 11, wherein cleansing the first well log data comprises:
scaling the first well log data to produce scaled well log data, wherein the first well log data is scaled to a normalized range to provide uniformity across different measurements in the first well log data, and wherein the first well log data is scaled using a minmaxscaler; and
splitting the scaled well log data into the first sequences to produce the cleansed well log data, wherein the scaled well log data is split based upon one or more defined window sizes, and wherein the cleansed well log data is in a 2D array.

13. The computing system of claim 11, wherein training the CNN comprises:
applying filters to the cleansed well log data to produce filtered well log data, wherein applying the filters detects spatial patterns within the first sequences, and wherein the applying the filters comprises passing the first sequences through one or more convolutional one-dimensional layers of the CNN;
reducing a dimensionality of the filtered well log data to produce reduced well log data, wherein reducing the dimensionality comprises passing the filtered well log data through one or more maxpooling one-dimensional layers of the CNN;
connecting and regularizing the reduced well log data to produce connected and regularized well log data, wherein connecting and regularizing the reduced well log data generalizes the reduced well log data and prevents overfitting within the reduced well log data, and wherein connecting and regularizing the reduced well log data comprises passing the reduced well log data through one or more dense and dropout layers of the CNN;
converting the connected and regularized well log data from a multi-dimensional output into a one-dimensional vector using a flatten layer of the CNN;
predicting a binary classification for the first formation tops in the first wells based upon the one-dimensional vector, wherein the binary classification is predicted using a dense layer of the CNN, and wherein the dense layer comprises sigmoid activation; and
training the CNN with a binary cross-entropy loss function that is configured to distinguish the first sequences containing the first marker tops from those without the first marker tops, wherein the binary cross-entropy loss function is determined or based upon the binary classification.

14. The computing system of claim 11, wherein the operations further comprise displaying the second formation tops.

15. The computing system of claim 11, wherein the operations further comprise performing a wellsite action based upon or in response to the second formation tops, wherein the wellsite action comprises generating or updating a model of the subsurface.

16. A non-transitory computer-readable medium storing instructions that, when executed by one or more processors of a computing system, cause the computing system to perform operations, the operations comprising:
receiving first well log data corresponding to a plurality of first wells formed in a subsurface, wherein the first well log data comprises first marker tops in the first wells;
cleansing the first well log data to produce cleansed well log data, wherein the cleansed well log data comprises a plurality of first sequences, wherein each of the first sequences represents a slice of the first well log data, and wherein labels on the first sequences indicate a presence or absence of first formation tops within the first sequences;
training a convolutional neural network (CNN) using the cleansed well log data to produce a trained CNN;
receiving second well log data corresponding to a plurality of second wells formed in the subsurface, wherein the second well log data comprises a plurality of second sequences; and
identifying second formation tops in the second well log data using the trained CNN, wherein identifying the second formation tops comprises predicting a probability that one or more second marker tops is in each of the second sequences in the second well log data.

17. The non-transitory computer-readable medium of claim 16, wherein cleansing the first well log data comprises:
scaling the first well log data to produce scaled well log data, wherein the first well log data is scaled to a normalized range to provide uniformity across different measurements in the first well log data, and wherein the first well log data is scaled using a minmaxscaler; and
splitting the scaled well log data into the first sequences to produce the cleansed well log data, wherein the scaled well log data is split based upon one or more defined window sizes, and wherein the cleansed well log data is in a 2D array.

18. The non-transitory computer-readable medium of claim 17, wherein training the CNN comprises:
applying filters to the cleansed well log data to produce filtered well log data, wherein applying the filters detects spatial patterns within the first sequences, and wherein the applying the filters comprises passing the first sequences through one or more convolutional one-dimensional layers of the CNN;
reducing a dimensionality of the filtered well log data to produce reduced well log data, wherein reducing the dimensionality comprises passing the filtered well log data through one or more maxpooling one-dimensional layers of the CNN;
connecting and regularizing the reduced well log data to produce connected and regularized well log data, wherein connecting and regularizing the reduced well log data generalizes the reduced well log data and prevents overfitting within the reduced well log data, and wherein connecting and regularizing the reduced well log data comprises passing the reduced well log data through one or more dense and dropout layers of the CNN;
converting the connected and regularized well log data from a multi-dimensional output into a one-dimensional vector using a flatten layer of the CNN;
predicting a binary classification for the first formation tops in the first wells based upon the one-dimensional vector, wherein the binary classification is predicted using a dense layer of the CNN, and wherein the dense layer comprises sigmoid activation; and
training the CNN with a binary cross-entropy loss function that is configured to distinguish the first sequences containing the first marker tops from those without the first marker tops, wherein the binary cross-entropy loss function is determined or based upon the binary classification.

19. The non-transitory computer-readable medium of claim 18, wherein predicting the probability comprises determining an area of a deviation of the second sequences from a predicted probability log, and wherein as the area increases, the probability increases.

20. The non-transitory computer-readable medium of claim 19, wherein the operations further comprise:
filtering the second formation tops to those within a portion of the area where the probability is highest to produce filtered formation tops;
displaying the filtered formation tops; and
performing a wellsite action based upon or in response to the filtered formation tops, wherein the wellsite action comprises generating or updating a model of the subsurface.
